(19) United States
(12) Patent Application Publication
(10) Pub. No.: US 2018/0201825 A1
(43) Pub. Date: Jul. 19, 2018

(54) COATING FOR CAPTURING SULFIDES

(71) Applicant: Dow Global Technologies LLC, Midland, MI (US)

(72) Inventors: Arjun Raghuraman, Pearland, TX (US); Alexander Williamson, Rosharon, TX (US); Sachit Goyal, Houston, TX (US); Runyu Tan, Richwood, TX (US); Juan Carlos Medina, Lake Jackson, TX (US); Kaoru Aou, Lake Jackson, TX (US)

(21) Appl. No.: 15/740,237

(22) PCT Filed: Jun. 23, 2016
(86) PCT No.: PCT/US2016/039023

§ 371 Date: Dec. 27, 2017

Related U.S. Application Data
(60) Provisional application No. 62/186,669, filed on Jun. 30, 2015.
(60) Provisional application No. 62/186,671, filed on Jun. 30, 2015.
(60) Provisional application No. 62/186,645, filed on Jun. 30, 2015.
(60) Provisional application No. 62/287,037, filed on Jan. 26, 2016.

(51) Int. Cl. C09K 8/54; C09K 8/80

(52) U.S. Cl. CPC C09K 8/54; C09K 2208/20; C09K 8/805

(57) ABSTRACT

A coated proppant includes a solid core proppant particle, and a sulfide recovery coating that includes a sulfide capturing agent embedded within a polymer resin matrix. The sulfide capturing agent is a metal oxide.

### FIELD

Embodiments relate to coatings for articles such as proppants that are enabled for capturing of sulfides (e.g., recovery of sulfides, trapping of sulfides, and/or removal of hydrogen sulfide), proppants that have the coatings thereon, methods of making the coatings, and methods of coating the articles such as proppants with the coatings.

### Introduction

Generally, well fracturing is a process of injecting a fracturing fluid at high pressure into subterranean rocks, well holes, etc., so as to force open existing fissures and extract oil or gas therefrom. Proppants are solid material in particulate form for use in well fracturing. Proppants should be strong enough to keep fractures propped open in deep hydrocarbon formations, e.g., during or following an (induced) hydraulic fracturing treatment. Thus, the proppants act as a “propping agent” during well fracturing. The proppants may be introduced into the subterranean rocks, boreholes, etc., within the fracturing fluid. The proppants may be coated for providing enhanced properties such as hardness and/or crush resistance. It is also proposed that the proppants may be further coated to enable recovery of sulfides, such as by way of removing hydrogen sulfide.

### SUMMARY

Embodiments may be realized by providing a coated proppant that includes a solid core proppant particle, and a sulfide recovery coating that includes a sulfide capturing agent embedded within a polymer resin matrix. The sulfide capturing agent is a metal oxide. Also, embodiments may be realized by providing a coated article that includes a solid article (such as a an inner and/or outer surface of a pipe and/or pipeline), and a sulfide recovery coating that includes a sulfide capturing agent embedded within a polymer resin matrix, whereas the sulfide capturing agent is a metal oxide.

### DETAILED DESCRIPTION

Contaminated water produced from a well during well fracturing should be reused and/or treated to remove the contaminants. Typically, the contaminated water can be captured and treated. Exemplary treatment systems include packed beds of activated charcoal for the removal of organic compounds, permanent or portable ion exchange columns, electrodialysis and similar forms of membrane separation, freeze/thaw separation, spray evaporation, and combinations thereof. Dual function proppants are proposed in U.S. Pat. No. 8,763,700, which provide good conductivity in an oil or gas production well while also removing at least some of the impurities found in the contaminated downhole water and hydrocarbons.

Improved coatings, e.g., in the form of coatings for forming coated proppants, that combine the strength and/or flexibility of a polymer resin based coated (such as at least one selected from the group of a polyurethane based coating, an epoxy based coating, a phenolic resin based coating, and a furan-based coating) with a contaminant recovery substance are sought. For example, the coated proppants, according to exemplary embodiments, may incorporate/embed at least a sulfide capturing agent (also referred to as a sulfide recovery coating or sulfide recovery substance) into a polymer resin based matrix in order to provide strength and/or flexibility to both the overall coated proppant and the layer on the coated proppant that incorporates/embeds the sulfide capturing agent. According to exemplary embodiments, the sulfide capturing agent may have a low solubility in water, e.g., sulfide capturing agents that have a high solubility in water may be limited and/or avoided as the use of such agents may be disadvantageous for use in water-rich environments such as a process of well fracturing. For example, the sulfide capturing agent may have a water solubility of less than 10.0 mg/L at 29° C., less than 5.0 mg/L at 29° C., and/or less than 2.0 mg/L at 29° C.

With respect to sulfides such as hydrogen sulfide, contaminated water produced from the well during well fracturing may exhibit souring, which refers to an increased mass of hydrogen sulfide per unit mass of total production fluid. Typically, up to 3 parts per million by volume (ppmv) of hydrogen sulfide in the gas phase may be considered benign and well operations may be maintained such that a partial hydrogen sulfide pressure does not exceed 0.05 psia. If such levels are not maintained, operations may need to be temporary stopped to allow for tubing and/or wellhead replacement or upgrades, resulting in production loss. Further, failure to maintain acceptable levels of hydrogen sulfide in the contaminated water may lead to corrosion of casings (sulfide-stress corrosion cracking), mechanical failure, fluid leakage, and/or environmental contamination. Also, corrosion problems may be an issue for gas pipelines to transport natural gas, oil, and/or other hydrocarbons over long distances, such that the hydrocarbons may need to be treated so that hydrogen sulfide levels are below a certain specified limit (e.g., a limit specified by a pipeline operator and/or owner).

Hydrogen sulfide in oil or gas wells may result from biogenic or non-biogenic sources. Biogenic pathways for hydrogen sulfide may result from microbial contamination by sulfate-reducing bacteria, which convert sulfate to hydrogen sulfide in the absence of oxygen. Further, water used in well fracturing may be sourced from rivers, lakes, or wastewater impoundments where they have been stored for prolonged periods, and these water sources may be rich in bacteria. Non-biogenic pathways for hydrogen sulfide production including: (i) thermochemical sulfate reduction, (ii) decomposition of organic sulfur compounds, (iii) dissolution of pyritic material, and (iv) redox reactions involving bisulfite oxygen scavengers.

Modifying fracturing fluid, which is fed into the oil or gas wells and later recovered as contaminated water, to include compounds that may control hydrogen sulfide such as biocides to kill bacteria, may not be productive to control non-biogenic pathways for hydrogen sulfide production. Further, the hydrolytic and thermal stability of biocides and their ability to be placed and kept downhole may hinder such uses.

Accordingly, embodiments relate to providing a system in which sulfides such as hydrogen sulfide may be removed from contaminated water, e.g., can be absorbed into/onto a matrix and/or may be chemically altered. For example, the sulfide may be chemically altered to form sulfur dioxide. In particular, embodiments relate to providing a sulfide capturing agent embedded within a polymer resin matrix, which is coated onto a solid core proppant particle. The sulfide capturing agent on the proppant particle may aid in the recovery and/or removal of sulfides from the contaminated water.

The polymer resin matrix having the sulfide capturing agent may act as a permeable or semi-permeable polymer resin, with respect to hydrogen sulfide and/or sulfur ions. For example, the hydrogen sulfide and/or sulfur ions may be rendered immobile on an outer surface of the proppant particle and/or rendered immobile within the polymer resin matrix. The polymer resin matrix, polymer coating, and/or the process used to prepare coated proppants may be designed to retain captured sulfide on or within the coatings of the proppants and keep the product in the fracture. The coated proppants may have the benefit of sequestering, deep underground, the hydrogen sulfide and/or sulfur ions rendered immobile on an outer surface of the proppant particle and/or rendered immobile within the polymer resin matrix, so that above ground at the well head, little or no treatment for hydrogen sulfide and/or sulfur ions may be necessary. The polymer resin matrix may provide the additional benefit of being formulated to maintain its properties even when exposed to high temperature, e.g., to temperatures of at least 70° C. The performance of coatings for proppants, especially in down well applications at higher temperatures (such as greater than 120° C.) and elevated pressures (such as in excess of 6000 psig), may be further improved by designing a multilayer coating structure, where the top layer may be permeable or semi-permeable, while the undercoat layer may be composed of polymer resin matrix that can retain a high storage modulus at high temperatures (such as up to at least 175° C.), which may be typically encountered during hydraulic fracturing of deep strata. For example, the underlying polymer resin matrix may include polyurethane based polymers and/or epoxy based polymers (which encompasses polyurethane/epoxy hybrid polymers), which offer various advantages in resin-coated proppant applications, e.g., such as ease of processing, and/or rapid cure rates that enable short cycle times for forming the coating. Further, polyurethane polymers and/or epoxy polymers may be readily formulated to provide a permeable or semi-permeable layer with one formulation, and a high storage modulus layer with another formulation, in some cases using the same combination of raw materials but at different ratios.

In embodiments, a solid core proppant particle is coated with at least a sulfide recovery coating that includes at least the sulfide recovery substance, which are embedded within and/or on a polymer resin matrix. The solid core proppant article may be coated with additional additives, such as additives for recovery and/or removal of other contaminates. The sulfide recovery coating may be at least a dual function coating that provides the benefit of sulfide recovery and the additional benefit associated with resin coatings on proppants. The coating proppant may include one or more sulfide recovery coatings/layers. The coating proppant may include one or more polymer resin coating/layers, e.g., one or more polyurethane based coatings/layers, one or more epoxy based coatings/layers (which encompasses one or more polyurethane/epoxy hybrid based coatings/layers), one or more phenolic-resin based coatings/layers. The coated proppant may include additional coatings/layers derived from one or more preformed isocyanurate tri-isocyanates and one or more curatives. The different coatings/layers may be sequentially formed and/or may be formed at different times. The coated proppants may include a sulfide recovery coating that includes sulfide capturing crystals.

The sulfide recovery coating may be formed on a pre-formed polymer resin coated proppant or may be formed immediately after and/or concurrent with forming a polymer resin coating of a proppant. The sulfide recovery coating may be applied to proppant and/or composite applications. Exemplary composite applications include use of the sulfide recovery coating to coat the interior of tubes, pipe, and/or pipelines (e.g., that are used in well fracturing and/or waste water management).

### Coatings

In embodiments, a coated solid core proppant particle includes at least one sulfide recovery coating, which may be the top coat (outermost coating) forming the coated proppant. The coated solid core proppant particle may optional include additional coats/layers under the sulfide recovery coating. The sulfide recovery coating includes at least one sulfide capturing agent embedded on and/or within a polymer resin matrix, such as a polyurethane polymer matrix. The sulfide capturing agent may be sulfide capturing crystals. The sulfide capturing agent may be added during a process of forming the sulfide recovery coating and/or may be sprinkled onto a previously coated solid core proppant particle (e.g., added after applying an underlying layer) to form the sulfide recovery coating in combination with the underlying layer. The sulfide recovery coating may include other additives, such as agents for heavy metal recovery.

For example, the sulfide capturing agent may be at least in part embedded with a matrix of a polymer resin, such that optionally the sides of the sulfide capturing agent are encapsulated by the polymer resin. The sulfide capturing agent may be at least in part directly on to top of the matrix of polymer resin, so that bottom surfaces of the sulfide capturing agent are surrounded by the polymer resin. The sulfide capturing agent may account for less than 10.0 wt %, less than 5.0 wt %, less than 3.0 wt %, less than 2.0 wt %, and/or less than 1.5 wt % of a total weight of the coated proppant. The sulfide capturing agent may account for greater than 0.1 wt % of the total weight of the coated proppant. The sulfide capturing agent may account for 1 wt % to 99 wt % (e.g., 15 wt % to 85 wt %, etc.) of the total weight of the sulfide recovery coating. The amount of the sulfide capturing agent in the sulfide recovery coating may vary depending on how the sulfide recovery coating is formed, the overall thickness of the sulfide recovery coating, and/or whether the sulfide recovery coating is formed as a separate layer from any optional undercoat.

The sulfide capturing agent may be added as part of a one-component system or a two-component system. For example, the sulfide capturing agent may be used in a one-component polyurethane, phenolic, and/or epoxy system or a two-component polyurethane, phenolic, and/or epoxy systems. For example, the sulfide capturing agent may be incorporated into an isocyanate-reactive component for forming the sulfide recovery coating, an isocyanate component (e.g., a polyisocyanate and/or a prepolymer derived from an isocyanate and a prepolymer formation isocyanate-reactive component) for forming the sulfide recovery coating, the prepolymer formation isocyanate-reactive component, and/or a prepolymer derived from an isocyanate and a one component system formation isocyanate-reactive component (such as for a moisture cured one-component polyurethane system).

Exemplary sulfide capturing agents are metal oxides. For example, the metal oxides may be derived from metals described as Period 4 Elements in the periodic table of elements. Exemplary metal oxides include zinc oxides, iron oxides, titanium oxides, and/or combinations thereof. Examples include zinc oxide, zinc-titanium oxide, and magnetite. The microstructure of the sulfide capturing agent may allow for the metal, such as zinc, to react with hydrogen sulfide to form zinc sulfide and water.

The sulfide capturing agents (e.g., sulfide capturing crystals) are solids at room temperature (approximately 23° C.). The sulfide capturing crystals may have a melting point greater than 500° C., greater than 800° C., and/or greater than 1000° C. The melting point of sulfide capturing crystals may be less than 2500° C. The sulfide capturing crystals may be metallic materials that form a crystalline matrix (also referred to as a crystal lattice) appropriately sized to allow for absorption of sulfides. The sulfide capturing agents, such as the sulfide capturing crystals, may have an average particle size of less than 5 μm (e.g., less than 4 μm, less than 2 μm, less than 1 μm, etc.) For example, the average particle size may be from 25 nm to 500 nm (e.g., 25 nm to 250 nm, 50 nm to 200 nm, 100 nm to 200 nm, etc.) The sulfide capturing agent may account for 90 wt % to 100 wt % (e.g., 99 wt % to 100 wt %) of a crystalline content in the sulfide recovery coating. The sulfide capturing agents may be of low solubility in water.

The sulfide capturing agents may be added directly and/or also as a slurry in water, during a process of forming the sulfide recovery coating. Optionally, the sulfide capturing agents may be provided in a carrier polymer when forming the sulfide recovery coating. Exemplary carrier polymers include simple polyols, polyether polyols, polyester polyols, liquid epoxy resin, liquid acrylic resins, polyacids such as polyacrylic acid, a polystyrene based copolymer resins (exemplary polystyrene based copolymer resins include crosslinked polystyrene-divinylbenzene copolymer resins), Novolac resins made from phenol and formaldehyde (exemplary Novolac resins have a low softening point), and combinations thereof. More than one carrier polyol may be used, e.g., a combination of a liquid epoxy resin with sulfide capturing agents therein and a carrier polyol with sulfide capturing agents therein may be used. The carrier polyol may be a resin that is crosslinkable so as to provide a permeable or semi-permeable layer on the solid core proppant particle.

The carrier polymer may be present in an amount from 15 wt % to 85 wt %, based on the total weight of the sulfide capturing agents and the carrier polymer. The carrier polymer may include a blend of different polymers, e.g., a blending of polyols. The amount of the carrier polymer used may be lower when the sulfide recovery coating is formed immediately after a polymer resin undercoat layer is formed (e.g., a polyurethane based undercoat layer), e.g., the amount of the carrier polymer may be from, e.g., 20 wt % to 80 wt %, 30 wt % to 80 wt %, 40 wt % to 80 wt %, 50 wt % to 80 wt %, 50 wt % to 75 wt %, etc., based on the total weight of the sulfide capturing agents and the carrier polyol. In an exemplary embodiment, the carrier polymer may be a mixture of a hydrophilic polymer in water (e.g., glycerol, blend of glycerol and a hydrophilic polyether polyol available from the Dow Chemical Company, a blend of water and the hydrophilic polyether polyol, and/or a blend glycerol, water, and the hydrophilic polyether polyol. The inclusion of water may help mitigate zinc oxide agglomeration of hydrophilic zinc oxide grades in the resultant coating. The amount of the carrier polymer used may be higher when the sulfide recovery coating is formed concurrent with a polymer resin layer such as a polyurethane based layer, epoxy based layer, and/or phenolic resin based layer (i.e., a prior polymer resin undercoat layer is not formed). In exemplary embodiments, the carrier polymer includes one or more simple polyols, one or more polyether polyols, one or more liquid epoxy resins, one or more phenolic resins, and/or combinations thereof.

In exemplary embodiments, the carrier polymer may include one or more carrier polyols having a number average molecular weight from 60 g/mol to 6000 g/mol. The carrier polyol may have on average from 1 to 8 hydroxyl groups per molecule, e.g., from 2 to 4 hydroxyl groups per molecule. For example, the one or more carrier polyols may independently be a diol or triol.

In some exemplary embodiments, the carrier polymer has a number average molecular weight, e.g., 60 g/mol to 3000 g/mol, 60 g/mol to 2000 g/mol, 60 g/mol to 1500 g/mol, 60 g/mol to 1000 g/mol, 60 g/mol to 500 g/mol, 60 g/mol to 400 g/mol, 60 g/mol to 300 g/mol, etc. For example, the carrier polymer include a simple polyol that includes at least two —OH moieties, and has a number average molecular weight from 60 g/mol to 500 g/mol (e.g., from 60 g/mol to 400 g/mol, 60 g/mol to 300 g/mol, etc.). Exemplary simple polyols may consist of Carbon, Oxygen, and Hydrogen. Exemplary simple polyols include ethylene glycol, diethylene glycol, triethylene glycol, 1,2-propanediol, dipropylene glycol, tripropylene glycol, 1,4-butanediol, 1,6-hexanediol, glycerol, and the like simple polyols that may be used as the initiator for forming a polyether polyol (as would be understood by a person of ordinary skill in the art).

In exemplary embodiments, the carrier polymer may include a polyether polyol that has a high number average molecular weight, e.g., from 300 g/mol to 3000 g/mol, 300 g/mol to 1500 g/mol, 500 g/mol to 1000 g/mol, etc. For example, the polyether polyol may be a hydrophilic polyol, e.g., an ethylene oxide (EO) rich polyether polyol that has an EO content of greater than 50 wt % (e.g., from 60 wt % to 95 wt %, 65 wt % to 90 wt %, 70 wt % to 85 wt %, etc.), based on the total weight of the ethylene oxide rich polyether polyol. EO content is calculated by the mass of EO monomer units reacted into the polyether polyol divided by the total mass of the polyether polyol. So for polyols with water, ethylene glycol, diethylene glycol, or other linear oligomers of EO used as initiator, the EO content may be as high as 100 wt %, but for other initiators, the maximum EO content may be lower than 100 wt %.

The carrier polyol may include any combination thereof, e.g., a combination of the polyether polyol and the simple polyol. For example, the carrier polyol may include from 1 wt % to 99 wt % (e.g., 20 wt % to 95 wt %, 30 wt % to 95 wt %, 40 wt % to 95 wt %, 50 wt % to 95 wt %, 60 wt % to 95 wt %, etc.) of one or more polyether polyols and from 1 wt % to 99 wt % (e.g., 5 wt % to 80 wt %, 5 wt % to 70 wt %, 5 wt % to 60 wt %, 5 wt % to 50 wt %, 5 wt % to 40 wt %, etc.) of one or more simple polyols.

In exemplary embodiments, the carrier polymer may include a liquid epoxy resin that forms an epoxy based matrix in a final curable formulation. For example, useful epoxy compounds may include any conventional epoxy compound. The epoxy compound used, may be, e.g., a single epoxy compound used alone or a combination of two or more epoxy compounds known in the art such as any of the epoxy compounds described in Lee, H. and Neville, K., Handbook of Epoxy Resins, McGraw-Hill Book Company, New York, 1967, Chapter 2, pages 2-1 to 2-27. The epoxy resin may be based on reaction products of polyfunctional alcohols, phenols, cycloaliphatic carboxylic acids, aromatic amines, or aminophenols with epichlorohydrin. For example, the liquid epoxy resin may be based on bisphenol A diglycidyl ether, bisphenol F diglycidyl ether, resorcinol diglycidyl ether, or triglycidyl ethers of para-aminophenols. Other exemplary epoxy resins include reaction products of epichlorohydrin with o-cresol and, respectively, phenol novolacs. Exemplary, commercially available epoxy related products include, e.g., D.E.R.™ 331, D.E.R.™ 332, D.E.R.™ 334, D.E.R.™ 580, D.E.N.™ 431, D.E.N.™ 438, D.E.R.™ 736, or D.E.R.™ 732 epoxy resins available from Olin Epoxy. In exemplary embodiments, when the liquid epoxy resin is used as a carrier polymer, a polyurethane based undercoat may be formed on the solid core proppant particle.

In embodiments, the polymer resin matrix includes, e.g., one or more polyurethane resins, one or more epoxy resins, one or more polyurethane/epoxy hybrid resins, and/or one or more phenolic-formaldehyde resins. Optionally, one or more polymer resin based undercoats may be formed under the polymer resin matrix of the sulfide recovery coating, e.g., one or more phenolic-formaldehyde resin based undercoats, one or more epoxy resin based undercoats, and/or one or more polyurethane resin based undercoats. For example, the phenolic-formaldehyde resin, epoxy resin, and/or polyurethane resin based undercoat layer may be a coating that is known in the art, e.g., known in the art for coating proppants. For example, for forming a permeable or semi-permeable layer, flexible epoxy resins (such D.E.R.™ 736, D.E.R.™ 732, D.E.R.™ 750, D.E.R.™ 3913, and any combination of the preceding, available from Olin Epoxy may be used.

Optionally, additional coatings/layers, e.g., a coating/layer derived from one or more preformed isocyanurate tri-isocyanates and one or more curatives, may be formed under the polymer resin matrix. For example, at least one additional coating/layer derived from one or more preformed isocyanurate tri-isocyanates may be formed between a polymer resin based undercoat and the sulfide recovery coating. In exemplary embodiments, the polymer resin matrix is a polyurethane based matrix, and the optional one or more polymer resin based undercoats (if included) includes at least one polyurethane resin and/or epoxy resin based undercoat. In exemplary embodiments, the polymer resin matrix is an epoxy based matrix, the optional one or more polymer resin based undercoats (if included) includes at least one polyurethane based undercoat and/or epoxy resin based undercoat (which encompasses polyurethane/epoxy hybrid undercoats). For example, the optional polymer resin based undercoat includes at least 75 wt %, at least 85 wt %, at least 95 wt %, and/or at least 99 wt % of polyurethane resins, epoxy resins, and/or polyurethane/epoxy hybrid resins, based on the total weight of the resins in the resultant coating.

For example, the sulfide recovery agent, such as zinc oxide, may be embedded into a polyurethane based matrix, epoxy based matrix, and/or phenolic resin matrix which acts as a permeable or semi-permeable polymer resin, on the solid core proppant particle. In exemplary embodiments, the zinc oxide is embedded within a matrix that includes polyurethane polymers, epoxy polymers, or hybrid polyurethane/epoxy polymers. The sulfur ions may be rendered immobile on an outer surface of the proppant particle surface by the sulfide recovery agent and/or the polyurethane based matrix and/or epoxy based matrix; and/or the sulfur ions may be rendered immobile embedded within the polyurethane based matrix and/or epoxy based matrix. The polyurethane based matrix may additionally provide benefits associated with proppants having a polyurethane based coating thereon, such as enhanced strength. The epoxy based matrix may additionally provide benefits associated with an epoxy coating.

### Polyurethane Coating

For example, polyurethane based matrix may be the reaction product of an isocyanate component and an isocyanate-reactive component. For a polyurethane based matrix, the isocyanate component may include a polyisocyanate and/or an isocyanate-terminated prepolymer and the isocyanate-reactive component may include a polyether polyol. For a polyurethane/epoxy hybrid based matrix, the isocyanate component may include a polyisocyanate and/or an isocyanate-terminated prepolymer and the isocyanate-reactive component may include an epoxy resin containing hydroxyl groups and optionally a polyether polyol. Similarly, the optional one or more polyurethane based undercoats, under the sulfide recovery coating, may be the reaction product of a same or a different isocyanate component and a same or a different isocyanate-reactive component. In exemplary embodiments, a single isocyanate component may be used to form both a polyurethane based undercoat and a separately formed polyurethane based matrix. For example, a first isocyanate-reactive component may be added to solid core proppant particles to start the formation of the polyurethane based undercoat, then a first isocyanate component may be added to the resultant mixture to form the polyurethane based undercoat, and then a second isocyanate-reactive component (e.g., that includes the sulfide capturing crystals in the carrier polyol) may be added to the resultant mixture to form the sulfide recovery coating. In other exemplary embodiments, one isocyanate-reactive component (e.g., that includes the sulfide capturing crystals in one or more polyols that includes at least a carrier polyol) and one isocyanate component may be used to form the polyurethane based matrix and formation of an additional coating thereunder may be excluded.

The isocyanate-reactive component includes at least a polyol that has a number average molecular weight from 60 g/mol to 6000 g/mol (and optionally additional polyols) and includes a catalyst component having at least a catalyst (and optionally additional catalysts). The mixture for forming the polyurethane based matrix may have an isocyanate index that is at least 60 (e.g., at least 100). The polyurethane based matrix may be highly resistant to the conditions encountered in immersion in fracturing fluids at elevated temperatures. For example, the polyurethane based matrix used may be similar to a polyurethane coating discussed in, e.g., U.S. Patent Publication No. 2013/0065800.

For forming the polyurethane based matrix and/or the optional polyurethane based undercoat, the amount of the isocyanate component used relative to the isocyanate-reactive component in the reaction system expressed as the isocyanate index. For example, the isocyanate index may be from 60 to 2000 (e.g., 65 to 1000, 65 to 300, 65 to 250 and/or 70 to 200 etc.). The isocyanate index is the equivalents of isocyanate groups (i.e., NCO moieties) present, divided by the total equivalents of isocyanate-reactive hydrogen containing groups (i.e., OH moieties) present, multiplied by 100. Considered in another way, the isocyanate index is the ratio of the isocyanate groups over the isocyanate reactive hydrogen atoms present in a formulation, given as a percentage. Thus, the isocyanate index expresses the percentage of isocyanate actually used in a formulation with respect to the amount of isocyanate theoretically required for reacting with the amount of isocyanate-reactive hydrogen used in a formulation.

The isocyanate component for forming the polyurethane based matrix (including a polyurethane/epoxy hybrid based matrix) and/or the polyurethane based undercoat may include one or more polyisocyanates, one or more isocyanate-terminated prepolymer derived from the polyisocyanates, and/or one or more quasi-prepolymers derived from the polyisocyanates. Isocyanate-terminated prepolymers and quasi-prepolymers (mixtures of prepolymers with unreacted polyisocyanate compounds), may be prepared by reacting a stoichiometric excess of a polyisocyanate with at least one polyol. Exemplary polyisocyanates include aromatic, aliphatic, and cycloaliphatic polyisocyanates. According to exemplary embodiments, the isocyanate component may only include aromatic polyisocyanates, prepolymers derived therefrom, and/or quasi-prepolymers derived therefrom, and the isocyanate component may exclude any aliphatic isocyanates and any cycloaliphatic polyisocyanates. The polyisocyanates may have an average isocyanate functionality from 1.9 to 4 (e.g., 2.0 to 3.5, 2.8 to 3.2, etc.). The polyisocyanates may have an average isocyanate equivalent weight from 80 to 160 (e.g., 120 to 150, 125 to 145, etc.).

Exemplary isocyanates include toluene diisocyanate (TDI) and variations thereof known to one of ordinary skill in the art, and diphenylmethane diisocyanate (MDI) and variations thereof known to one of ordinary skill in the art. Other isocyanates known in the polyurethane art may be used, e.g., known in the art for polyurethane based coatings. Examples, include modified isocyanates, such as derivatives that contain biuret, urea, carbodiimide, allophonate and/or isocyanurate groups may also be used. Exemplary available isocyanate based products include PAPI™ products, ISONATE™ products and VORANATE™ products, VORASTAR™ products, HYPOL™ products, TERAFORCE™ Isocyanates products, available from The Dow Chemical Company.

The isocyanate-reactive component for forming the polyurethane based matrix (including a polyurethane/epoxy hybrid based matrix) and/or the polyurethane based undercoat includes one or more polyols that are separate from the optional carrier polyol or that include the optional carrier polyol. For example, if the isocyanate-reactive component is added at the same time as the sulfide capturing crystals, the isocyanate-reactive component may include the optional carrier polyol. If the optional polyurethane undercoat layer is formed before forming the sulfide recovery coating, the one or more polyols excludes the carrier polyol. The one or more polyols may have a number average molecular weight from 60 g/mol to 6000 g/mol (e.g., 150 g/mol to 3000 g/mol, 150 g/mol to 2000 g/mol, 150 g/mol to 1500 g/mol, 150 g/mol to 1000 g/mol, 150 g/mol to 500 g/mol, 150 g/mol to 400 g/mol, 150 g/mol to 300 g/mol, etc.). The one or more polyols have on average from 1 to 8 hydroxyl groups per molecule, e.g., from 2 to 4 hydroxyl groups per molecule. For example, the one or more polyols may independently be a diol or triol.

When the isocyanate-reactive component is used to form the sulfide recovery coating, the isocyanate-reactive component may include at least 50 wt %, at least 60 wt %, and/or at least 70 wt % of the one or more polyols (e.g., a low molecular weight polyol having a number average molecular weight of from 150 g/mol to 1000 g/mol), and the amount of the one or more polyols may be less than 90 wt % and/or less than 80 wt %, based on a total weight of the isocyanate-reactive component. When the isocyanate-reactive component is used to form an optional polyurethane based undercoat layer, the isocyanate-reactive component may include at least 80 wt % and/or at least 90 wt % of one or more low molecular weight polyols (e.g., a number average molecular weight of from 150 g/mol to 1000 g/mol), based on a total weight of the isocyanate-reactive component.

The one or more polyols may be alkoxylates derived from the reaction of propylene oxide, ethylene oxide, and/or butylene oxide with an initiator. Initiators known in the art for use in preparing polyols for forming polyurethane polymers may be used. For example, the one or more polyols may be an alkoxylate of any of the following molecules, e.g., ethylene glycol, diethylene glycol, triethylene glycol, 1,2-propanediol, dipropylene glycol, tripropylene glycol, 1,4-butanediol, 1,6-hexanediol, and glycerol. According to exemplary embodiments, the one or more polyols may be derived from propylene oxide and ethylene oxide, of which less than 20 wt % (e.g., and greater than 5 wt %) of polyol is derived from ethylene oxide, based on a total weight of the alkoxylate. According to another exemplary embodiment, the polyol contains terminal ethylene oxide blocks. According to other exemplary embodiments, the polyol may be the initiator themselves as listed above, without any alkylene oxide reacted to it.

In exemplary embodiments, the isocyanate-reactive component may include alkoxylates of ammonia or primary or secondary amine compounds, e.g., as aniline, toluene diamine, ethylene diamine, diethylene triamine, piperazine, and/or aminoethylpiperazine. For example, the isocyanate-reactive component may include polyamines that are known in the art for use in forming polyurethane-polyurea polymers. The isocyanate-reactive component may include one or more polyester polyols having a hydroxyl equivalent weight of at least 500, at least 800, and/or at least 1,000. For example, polyester polyols known in the art for forming polyurethane polymers may be used. The isocyanate-reactive component may include polyols with fillers (filled polyols), e.g., where the hydroxyl equivalent weight is at least 500, at least 800, and/or at least 1,000. The filled polyols may contain one or more copolymer polyols with polymer particles as a filler dispersed within the copolymer polyols. Exemplary filled polyols include styrene/acrylonitrile (SAN) based filled polyols, polyharnstoff dispersion (PHD) filled polyols, and polyisocyanate polyaddition products (PIPA) based filled polyols.

Exemplary available polyol based products include VORANOL™ products, TERAFORCE™ Polyol products, VORAPEL™ products, SPECFLEX™ products, VORALUX™ products, PARALOID™ products, VORARAD™ products, available from The Dow Chemical Company.

The isocyanate-reactive component for forming the polyurethane based matrix and/or the polyurethane based undercoat may further include a catalyst component. The catalyst component may include one or more catalysts. Catalysts known in the art, such as trimerization catalysts known in art for forming polyisocyanates trimers and/or urethane catalyst known in the art for forming polyurethane polymers and/or coatings may be used. In exemplary embodiments, the catalyst component may be pre-blended with the isocyanate-reactive component, prior to forming the coating (e.g., an undercoat or a sulfide recovery outer coating).

Exemplary trimerization catalysts include, e.g., amines (such as tertiary amines), alkali metal phenolates, alkali metal alkoxides, alkali metal carboxylates, and quaternary ammonium carboxylate salts. The trimerization catalyst may be present, e.g., in an amount less than 5 wt %, based on the total weight of the isocyanate-reactive component. Exemplary urethane catalyst include various amines, tin containing catalysts (such as tin carboxylates and organotin compounds), tertiary phosphines, various metal chelates, and metal salts of strong acids (such as ferric chloride, stannic chloride, stannous chloride, antimony trichloride, bismuth nitrate, and bismuth chloride). Exemplary tin-containing catalysts include, e.g., stannous octoate, dibutyl tin diacetate, dibutyl tin dilaurate, dibutyl tin dimercaptide, dialkyl tin dialkylmercapto acids, and dibutyl tin oxide. The urethane catalyst, when present, may be present in similar amounts as the trimerization catalyst, e.g., in an amount less than 5 wt %, based on the total weight of the isocyanate-reactive component. The amount of the trimerization catalyst may be greater than the amount of the urethane catalyst. For example, the catalyst component may include an amine based trimerization catalyst and a tin-based urethane catalyst.

### Epoxy Resin Based Coating

For example, epoxy resin based coatings (e.g., based on epoxy and epoxy hardener chemistry) have been proposed for use in forming coatings. As used herein, epoxy based coatings encompass the chemistry of an epoxy resin and an amine based epoxy hardener, with an amino hydrogen/epoxy resin stoichiometric ratio range over all possible stoichiometric ratios (e.g., from 0.60 to 3.00, from 0.60 to 2.00, from 0.70 to 2.0, etc.). Polyurethane based coatings (e.g., based on polyurethane chemistry), have been proposed for use in forming coatings on proppants such as sand and ceramics. As used herein, the term polyurethane encompasses the reaction product of a polyol (e.g., polyether polyol and/or polyester polyol) with an isocyanate index range over all possible isocyanate indices (e.g., from 50 to 1000). Polyurethanes offer various advantages in resin-coated proppant applications, e.g., such as ease of processing, base stability, and/or rapid cure rates that enable short cycle times for forming the coating. Polyurethane/epoxy hybrid coatings incorporate both epoxy based chemistry and polyurethane based chemistry to form hybrid polymers. For example, polyurethane/epoxy hybrid coatings may be formed by mixing and heating an epoxy resin containing hydroxyl groups, an isocyanate component (such as an isocyanate or an isocyanate-terminated prepolymer, and optionally a polyol component (e.g., may be excluded when an isocyanate-terminated prepolymer is used). Thereafter, an epoxy hardener may be added to the resultant polymer. Liquid epoxy resins known in the art may be used to form such a coating.

For example, for the epoxy based matrix, the liquid epoxy resin may be cured by one or more hardener, which may be any conventional hardener for epoxy resins. Conventional hardeners may include, e.g., any amine or mercaptan with at least two epoxy reactive hydrogen atoms per molecule, anhydrides, phenolics. In exemplary embodiments, the hardener is an amine where the nitrogen atoms are linked by divalent hydrocarbon groups that contain at least 2 carbon atoms per subunit, such as aliphatic, cycloaliphatic, or aromatic groups. For example, the polyamines may contain from 2 to 6 amine nitrogen atoms per molecule, from 2 to 8 amine hydrogen atoms per molecule, and/or 2 to 50 carbon atoms. Exemplary polyamines include ethylene diamine, diethylene triamine, triethylene tetramine, tetraethylene pentamine, pentaethylene hexamine, dipropylene triamine, tributylene tetramine, hexamethylene diamine, dihexamethylene triamine, 1,2-propane diamine, 1,3-propane diamine, 1,2-butane diamine, 1,3-butane diamine, 1,4-butane diamine, 1,5-pentane diamine, 1,6-hexane diamine, 2-methyl-1,5-pentanediamine, and 2,5-dimethyl-2,5-hexanediamine; cycloaliphatic polyamines such as, for example, isophoronediamine, 1,3-(bisaminomethyl)cyclohexane, 4,4′-diaminodicyclohexylmethane, 1,2-diaminocyclohexane, 1,4-diamino cyclohexane, isomeric mixtures of bis(4-aminocyclohexyl)methanes, bis(3-methyl-4-aminocyclohexyl)methane (BMACM), 2,2-bis(3-methyl-4-aminocyclohexyl)propane (BMACP), 2,6-bis(aminomethyl)norbornane (BAMN), and mixtures of 1,3-bis(aminomethyl)cyclohexane and 1,4-bis(aminomethyl)cyclohexane (including cis and trans isomers of the 1,3- and 1,4-bis(aminomethyl)cyclohexanes); other aliphatic polyamines, bicyclic amines (e.g., 3-azabicyclo[3.3.1]nonan); bicyclic imines (e.g., 3-azabicyclo[3.3.1]non-2-ene); bicyclic diamines (e.g. 3-azab‘i’cyclo[3.3.1]nonan-2-amine); heterocyclic diamines (e.g., 3,4 diaminofuran and piperazine); polyamines containing amide linkages derived from “dimer acids” (dimerized fatty acids), which are produced by condensing the dimer acids with ammonia and then optionally hydrogenating; adducts of the above amines with epoxy resins, epichlorohydrin, acrylonitrile, acrylic monomers, ethylene oxide, and the like, such as, for example, an adduct of isophoronediamine with a diglycidyl ether of a dihydric phenol, or corresponding adducts with ethylenediamine or m-xylylenediamine; araliphatic polyamines such as, for example, 1,3-bis(aminomethyl)benzene, 4,4′diaminodiphenyl methane and polymethylene polyphenylpolyamine; aromatic polyamines (e.g., 4,4′-methylenedianiline, 1,3-phenylenediamine and 3,5-diethyl-2,4-toluenediamine); amidoamines (e.g., condensates of fatty acids with diethylenetriamine, triethylenetetramine, etc.); polyamides (e.g., condensates of dimer acids with diethylenetriamine, triethylenetetramine; oligo(propylene oxide)diamine; and Mannich bases (e.g., the condensation products of a phenol, formaldehyde, and a polyamine or phenalkamines). Mixtures of more than one diamine and/or polyamine can also be used.

### Phenolic Resin Based Coating

For example, the phenolic resin based matrix may be prepared using curable or pre-cured phenolic materials, such as arylphenol, alkylphenol, alkoxyphenol, and/or aryloxyphenol based phenolic materials. The phenolic resin matrix may be formed using one or more curable or pre-cured phenolic thermoset resins. The phenolic thermoset resins may be made by crosslinking phenol-formaldehyde resins with crosslinkers (such as hexamethylenetetramine) Exemplary phenolic resin coatings for proppants are discussed in U.S. Pat. No. 3,929,191, U.S. Pat. No. 5,218,038, U.S. Pat. No. 5,948,734, U.S. Pat. No. 7,624,802, and U.S. Pat. No. 7,135,231.

According to exemplary embodiments, there are two types of phenolic resins that may be used (1) Novolac (phenol to formaldehye ratio is >1), an exemplary structure is shown below where n is an integer of 1 or greater, and (2) Resole (phenol to formaldehye ratio is <1), an exemplary structure is shown below where n is an integer of 1 or greater. Novolac resins may use a crosslinker. Resole resins may not use a crosslinker.

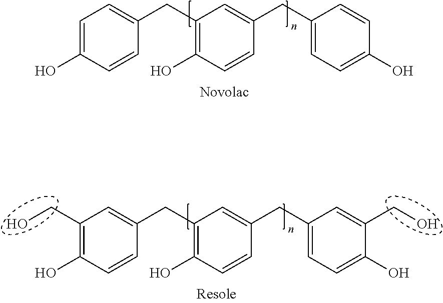

A silane coupling agent may be used, e.g., to generate bond strength, when forming a phenolic resin coating, an exemplary coating is discussed in U.S. Pat. No. 5,218,038. Optionally a lubricant may be added at the end of the process of forming the phenolic resin coating.

For forming an exemplary phenolic resin coating, Novolak resin or alkylphenol-modified novolak resin, or a mixture thereof, is added to the hot sand and mixed. Optionally, one or more additives, such as a silane coupling agent, may be added in a desired amount. Then, to the resultant mixture may be stirred until it has advanced above a desired melt point of the resin (e.g., 35° C. as a minimum). The degree of resin advancing or increasing in molecular weight during the mixing or coating may be important to achieve the desired melt point and resin composition properties. Water may then be added in an amount sufficient to quench the reaction.

### Other Coatings

Under or embedded with the sulfide recovery coating, may be a heavy metal recovery coating such as discussed in priority document, U.S. Provisional Patent Application No. 62/186,645. In particular, the heavy metal recovery coating may have heavy metal recovery crystals embedded within a polymer resin matrix, which is coated onto a solid core proppant particle. The metal sulfate crystals on the proppant particle may aid in heavy metal recovery by causing heavy metals, such as particles of radioactive radium, to partition onto the coated proppant and away from the contaminated water. The selective post-precipitation of heavy metals such radium ions onto previously formed crystals (e.g., barite crystals) by lattice replacement (lattice defect occupation), adsorption, or other mechanism, is distinctly different from other capture modes such as ion exchange or molecular sieving. For example, the post precipitation of heavy metals such as radium on pre-formed barite crystals is selective for radium because of similar size and electronic structure of radium and barium. In exemplary embodiments, the heavy metal recovery crystals may form a crystalline structure that is appropriately sized to hold the heavy metals such as radium thereon or therewithin. Therefore, the heavy metal recovery crystals may pull the radium out of fracturing fluid and hold the ions on or within the heavy metal recovery coating, so as to reduce radium content in the fracturing fluid.

In exemplary embodiments, the sulfide recovery coating may include both the sulfide capturing agent and the heavy metal recovery crystals embedded within a same polymer resin matrix, to form both the sulfide recovery coating and the heavy mental recovery coating.

Under or combined with the sulfide recovery coating, optionally at least one additional coating/layer derived from one or more preformed isocyanurate tri-isocyanates may be formed. For example, the additional coating/layer may be formed between a polymer resin based undercoat and the sulfide recovery coating. In embodiments, the additional layer is derived from a mixture that includes one or more preformed isocyanurate tri-isocyanates and one or more curatives. The preformed isocyanurate tri-isocyanate may also be referred to herein as an isocyanate trimer and/or isocyanurate trimer. By preformed it is meant that the isocyanurate tri-isocyanate is prepared prior to making a coating that includes the isocyanurate tri-isocyanate there within. Accordingly, the isocyanurate tri-isocyanate is not prepared via in situ trimerization during formation of the coating. In particular, one way of preparing polyisocyanates trimers is by achieving in situ trimerization of isocyanate groups, in the presence of suitable trimerization catalyst, during a process of forming polyurethane polymers. For example, the in situ trimerization may proceed as shown below with respect to Schematic (a), in which a diisocyanate is reacted with a diol (by way of example only) in the presence of both a urethane catalyst and a trimerization (i.e. promotes formation of isocyanurate moieties from isocyanate functional groups) catalyst. The resultant polymer includes both polyurethane polymers and polyisocyanurate polymers, as shown in Schematic (a), below.

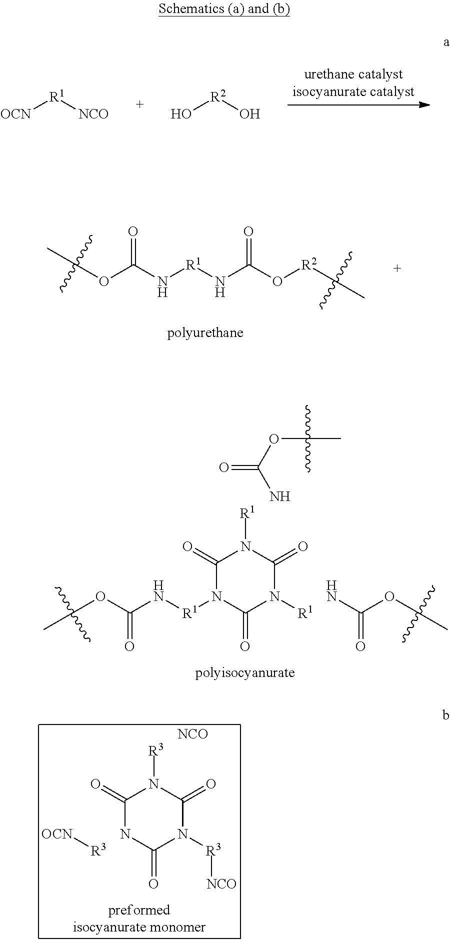

In contrast, referring to Schematic (b) above, in embodiments the preformed isocyanurate tri-isocyanate is provided as a separate preformed isocyanurate-isocyanate component, i.e., is not mainly formed in situ during the process of forming polyurethane polymers. The preformed isocyanurate tri-isocyanate may be provided in a mixture for forming the coating in the form of a monomer, and not in the form of being derivable from a polyisocyanate monomer while forming the coating. For example, the isocyanate trimer may not be formed in the presence of any polyols and/or may be formed in the presence of a sufficiently low amount of polyols such that a polyurethane forming reaction is mainly avoided (as would be understand by a person of ordinary skill in the art). With respect to the preformed isocyanurate tri-isocyanate, it is believed that the existence of isocyanurate rings leads to a higher crosslink density. Further, the higher crosslink density may be coupled with a high decomposition temperature of the isocyanurate rings, which may lead to enhanced temperature resistance. Accordingly, it is proposed to introduce a high level of isocyanurate rings in the coatings for proppants using the preformed isocyanurate tri-isocyanates.

For example, the additional layer may include one or more preformed aliphatic isocyanate based isocyanurate tri-isocyanates, one or more preformed cycloaliphatic isocyanate based isocyanurate tri-isocyanates, or combinations thereof. In exemplary embodiments, the additional layer is derived from at least a preformed cycloaliphatic isocyanate based isocyanurate tri-isocyanate, e.g., the preformed cycloaliphatic isocyanate based isocyanurate tri-isocyanate may be present in an amount from 80 wt % to 100 wt %, based on the total amount of the isocyanurate tri-isocyanates used in forming the additional layer.

Exemplary preformed isocyanurate tri-isocyanates include the isocyanurate tri-isocyanate derivative of 1,6-hexamethylene diisocyanate (HDI) and the isocyanurate tri-isocyanate derivative of isophorone diisocyanate (IPDI). For example, the isocyanurate tri-isocyanates may include an aliphatic isocyanate based isocyanurate tri-isocyanates based on HDI trimer and/or cycloaliphatic isocyanate based isocyanurate tri-isocyanates based on IPDI trimer. Many other aliphatic and cycloaliphatic di-isocyanates that may be used (but not limiting with respect to the scope of the embodiments) are described in, e.g., U.S. Pat. No. 4,937,366. It is understood that in any of these isocyanurate tri-isocyanates, one can also use both aliphatic and cycloaliphatic isocyanates to form an preformed hybrid isocyanurate tri-isocyanate, and that when the term “aliphatic isocyanate based isocyanurate tri-isocyanate” is used, that such a hybrid is also included.

The one or more curatives (i.e., curative agents) may include an amine based curative such as a polyamine and/or an hydroxyl based curative such as a polyol. For example the one or more curatives may include one or more polyols, one or more polyamines, or a combination thereof. Curative known in the art for use in forming coatings may be used. The curative may be added, after first coating the proppant with the preformed aliphatic or cycloaliphatic isocyanurate tri-isocyanate. The curative may act as a curing agent for both the top coat and the undercoat. The curative may also be added, after first coating following the addition of the preformed aliphatic or cycloaliphatic isocyanurate tri-isocyanate in the top coat.

The mixture for forming the additional layer may optionally include one or more catalysts. For example, urethane catalysts known in the art for forming polyurethane coatings may be used. Exemplary urethane catalyst include various amines (especially tertiary amines), tin containing catalysts (such as tin carboxylates and organotin compounds, e.g. stannous octoate and dibutyltin dilaurate), tertiary phosphines, various metal chelates, and metal salts of strong acids (such as ferric chloride, stannic chloride, stannous chloride, antimony trichloride, bismuth nitrate, and bismuth chloride).

The one or more catalysts may optionally be provided in a carrier polyol (e.g., that is the same or different from a carrier polyol used for the sulfide capturing crystals). For example, the carrier polyol may be a high number average molecular weight polyol. The carrier polyol may be present in an amount of at least 90 wt % (at least 93 wt %, at least 95 wt %, at least 97 wt %, etc.) and less than 99 wt %, based on the total weight of the one or more catalyst and the carrier polyol. The carrier polyol includes at least one polyol that has a number average molecular weight of at least 1000 g/mol (e.g., includes only one or more polyols having the average molecular weight of at least 1000 g/mol). For example, the carrier polyol may have a molecular weight from 3000 g/mol to 6000 g/mol (e.g., 4000 g/mol to 6000 g/mol, 4500 g/mol to 5500 g/mol, etc.). The carrier polyol may have on average from 1 to 8 hydroxyl groups per molecule, e.g., from 2 to 4 hydroxyl groups per molecule. For example, the carrier polyol be a diol or triol.

After forming the additional layer a surfactant may be added, e.g., concurrently with the curative and/or before addition of the curative. For example, the surfactant may be used to improve flow properties with respect to the coating and/or to improve the coating structure. It is believed that the surfactant may assist in enabling the formation of distinct layers on the proppants. Optionally, the isocyanate-to-hydroxyl reaction may be controlled (e.g., end time may be controlled) by adding an acidic compound such as phosphoric acid and/or acid phosphate at a desired conversion ratio.

Various optional ingredients may be included in the reaction mixture for forming the polymer resin matrix, polymer resin based undercoat, and/or the additional coating/layer. For example, reinforcing agents such as fibers and flakes that have an aspect ratio (ratio of largest to smallest orthogonal dimension) of at least 5 may be used. These fibers and flakes may be, e.g., an inorganic material such as glass, mica, other ceramic fibers and flakes, carbon fibers, organic polymer fibers that are non-melting and thermally stable at the temperatures encountered in the end use application. Another optional ingredient is a low aspect ratio particulate filler, that is separate from the proppant. Such a filler may be, e.g., clay, other minerals, or an organic polymer that is non-melting and thermally stable at the temperatures encountered in stages (a) and (b) of the process. Such a particulate filler may have a particle size (as measured by sieving methods) of less than 100 μm. With respect to solvents, the undercoat may be formed using less than 20 wt % of solvents, based on the total weight of the isocyanate-reactive component.

Another optional ingredient includes a liquid epoxy resin. The liquid epoxy resin may be added in amounts up to 20 wt %, based on the total weight of the reaction mixture. Exemplary liquid epoxy resins include the glycidyl polyethers of polyhydric phenols and polyhydric alcohols. Other optional ingredients include colorants, biocides, UV stabilizing agents, preservatives, antioxidants, and surfactants. Although it is possible to include a blowing agent into the reaction mixture to improve permeability, in some embodiments the blowing agent is excluded from the reaction mixture.

Prior to forming any coating of the solid core proppant particular (e.g., under the polymer resin matrix and/or the optional polymer resin based undercoat), a coupling agent may be added, e.g., prior to adding an isocyanate-reactive component. For example, the coupling agent may be a silane based compound such as an aminosilane compound.

### Proppants

Exemplary proppants (e.g., solid core proppant particles) include silica sand proppants and ceramic based proppants (for instance, aluminum oxide, silicon dioxide, titanium dioxide, zinc oxide, zirconium dioxide, cerium dioxide, manganese dioxide, iron oxide, calcium oxide, and/or bauxite). Various other exemplary proppant material types are mentioned in literature, such as glass beads, walnut hulls, and metal shot in, e.g., Application Publication No. WO 2013/059793, and polymer based proppants as mentioned by U.S. Patent Publication No. 2011/0118155. The sand and/or ceramic proppants may be coated with a resin to, e.g. to improve the proppant mesh effective strength (e.g., by distributing the pressure load more uniformly), to trap pieces of proppant broken under the high downhole pressure (e.g., to reduce the possibility of the broken proppants compromising well productivity), and/or to bond individual particles together when under the intense pressure and temperature of the fracture to minimize proppant flowback. The proppants to be coated may have an average particle size from 50 μm to 3000 μm (e.g., 100 μm to 2000 μm).

Proppant particle (grain or bead) size may be related to proppant performance. Particle size may be measured in mesh size ranges, e.g., defined as a size range in which 90% of the proppant fall within. In exemplary embodiments, the proppant is sand that has a mesh size of 20/40. Lower mesh size numbers correspond to relatively coarser (larger) particle sizes. Coarser proppants may allow higher flow capacity based on higher mesh permeability. However, coarser particles may break down or crush more readily under stress, e.g., based on fewer particle-to-particle contact points able to distribute the load throughout the mesh. Accordingly, coated proppants are proposed to enhance the properties of the proppant particle.

According to embodiments, the proppants are coated with at least a sulfide recovery coating that includes sulfide capturing crystals embedded within a polymer resin matrix. Optional one or more polymer resin undercoat layers and/or additional layers may be formed prior to forming the sulfide recovery coating. The optional polymer resin undercoat and/or additional layers may be formed immediately or soon after preceding formation of the sulfide recovery coating or a previously coated proppant may be coated with the sulfide recovery coating. The proppants may be coated with other layers, e.g., between an underlying layer and the solid core proppant particle, between an underlying layer and the sulfide recovery coating, and/or on the sulfide recovery coating opposing the solid core proppant particle. In exemplary embodiments, a polyurethane based undercoat is formed directly on the solid core proppant particle (e.g., which does not have a resin layer previously formed thereon) and the sulfide recovery layer having a polyurethane based matrix is formed on the polyurethane based undercoat. For example, the sulfide recovery layer may be directly on the polyurethane based undercoat or a layer derived from one or more preformed isocyanurate tri-isocyanates.

The performance of coatings for proppants, especially in downwell applications at higher temperatures (such as greater than 120° C.) and elevated pressures (such as in excess of 6000 psig), may be further improved by designing coatings that retain a high storage modulus at temperatures of up to at least 175° C., which may be typically encountered during hydraulic fracturing of deep strata. The coating may have a glass transition temperature greater than at least 140° C., e.g., may not realize a glass transition temperature at temperatures below 160° C., below 200° C., below 220° C., below 240° C., and/or below 250° C. The resultant coating may not realize a glass transition temperature within a working temperature range typically encountered during hydraulic fracturing of deep strata. For example, the resultant coating may not realize a glass transition temperature within the upper and lower limits of the range from 25° C. to 250° C. Accordingly, the coating may avoid a soft rubbery phase, even at high temperatures (e.g., near 200° C. and/or near 250° C.). For example, coatings that exhibit a glass transition temperature within the range of temperatures typically encountered during hydraulic fracturing of deep strata, will undergo a transition from a glassy to rubbery state and may separate from the proppant, resulting in failure.

A total amount of all the optional underlying layers may be from 0.5 wt % to 4.0 wt % (e.g., 1.0 wt % to 3.5 wt %, 1.5 wt % to 3.0 wt %, 2.0 wt % to 3.0 wt %, etc.), based on the total weight of the coated proppant. An amount of the sulfide recovery coating may be from 0.1 wt % to 3.5 wt % (e.g., 1.0 wt % to 3.5 wt %, 1.5 wt % to 3.5 wt %, 2.0 wt % to 3.0 wt %, etc.), based on the total weight of the coated proppant. A total amount of coatings on the proppant may be from 0.1 wt % to 6.0 wt %, based on the total weight of the coated proppant. For example, the ratio a polymer resin based undercoat to the sulfide recovery coating may be from 1:1 to 3:1, such that the amount of the top coat is equal to or less than the amount of the undercoat. A thickness of all the underlying undercoat layers may be from 1 μm to 50 μm. A thickness of the sulfide recovery coating may be from 0.1 μm to 30.0 μm (e.g., from 0.1 μm to 20.0 μm, from 0.1 μm to 10.0 μm, from 0.1 μm to 5.0 μm, from 0.1 to 2.5 μm, from 0.1 to 1.5 μm, from 0.1 μm to 1.0 μm, etc.). A thickness of the sulfide recovery coating may be less than a thickness of all of the optional underlying layers.

### Coating Process

To coat the article such as the proppant, in exemplary embodiments any optional undercoat layer (e.g., a polyurethane based layer) may be formed first. Thereafter, the sulfide recovery coating prepared using sulfide recovery crystals and the polymer resin matrix may be formed on (e.g., directly on) the article/proppant and/or the optional underlying undercoat. In a first stage of forming coated proppants, solid core proppant particles (e.g., which do not have a previously formed resin layer thereon) may be heated to an elevated temperature. For example, the solid core proppant particles may be heated to a temperature from 50° C. to 180° C., e.g., to accelerate crosslinking reactions in the applied coating. The pre-heat temperature of the solid core proppant particles may be less than the coating temperature for the coatings formed thereafter. For example, the coating temperate may be from 40° C. to 170° C. In exemplary embodiments, the coating temperature is at least 85° C. and up to 170° C.

Next, the heated proppant particles may be sequentially blended (e.g., contacted) with the desired components for forming the one or more coatings. For example, the proppant core particles may be blended with a first isocyanate-reactive component in a mixer, and subsequently thereafter other components for forming the desired one or more coatings. For an epoxy based matrix, the proppant core particles may be blended with a liquid epoxy resin (e.g., that acts as a carrier polymer for the sulfide recovery crystals) in the mixer. In exemplary embodiments, a process of forming the one or more coatings may take less than 10 minutes, after the stage of pre-heating the proppant particles and up until right after the stage of stopping the mixer.

The mixer used for the coating process is not restricted. For example, as would be understood by a person of ordinary skill in the art, the mixer may be selected from mixers known in the specific field. For example, a pug mill mixer or an agitation mixer can be used. The mixer may be a drum mixer, a plate-type mixer, a tubular mixer, a trough mixer, or a conical mixer. Mixing may be carried out on a continuous or discontinuous basis. It is also possible to arrange several mixers in series or to coat the proppants in several runs in one mixer. In exemplary mixers it is possible to add components continuously to the heated proppants. For example, isocyanate component and the isocyanate-reactive component may be mixed with the proppant particles in a continuous mixer in one or more steps to make one or more layers of curable coatings.

Any coating formed on the proppants may be applied in more than one layer. For example, the coating process may be repeated as necessary (e.g. 1-5 times, 2-4 times, and/or 2-3 times) to obtain the desired coating thickness. The thicknesses of the respective coatings of the proppant may be adjusted. For example, the coated proppants may be used as having a relatively narrow range of proppant sizes or as a blended having proppants of other sizes and/or types. For example, the blend may include a mix of proppants having differing numbers of coating layers, so as to form a proppant blend having more than one range of size and/or type distribution.

The coated proppants may be treated with surface-active agents or auxiliaries, such as talcum powder or steatite (e.g., to enhance pourability). The coated proppants may be exposed to a post-coating cure separate from the addition of the curative. For example, the post-coating cure may include the coated proppants being baked or heated for a period of time sufficient to substantially react at least substantially all of the available reactive components used to form the coatings. Such a post-coating cure may occur even if additional contact time with a catalyst is used after a first coating layer or between layers. The post-coating cure step may be performed as a baking step at a temperature from 100° C. to 250° C. The post-coating cure may occur for a period of time from 10 minutes to 48 hours.

All parts and percentages are by weight unless otherwise indicated. All molecular weight information is based on number average molecular weight, unless indicated otherwise.

### EXAMPLES

Approximate properties, characters, parameters, etc., are provided below with respect to various working examples, comparative examples, and the materials used in the working and comparative examples.

### Polyurethane Examples

For polyurethane based examples, the materials principally used, and the corresponding approximate properties thereof, are as follows:
Sand Northern White Frac Sand, having a 20/40 mesh size.
Coupling Agent A coupling agent based on aminopropyltrimethoxysilane (available as Silquest™ A-1100 from Momentive).
Polyol A blend of polyols (available from The Dow Chemical Company as TERAFORCE™ 62575 Polyol).
Zinc Oxide A powder that includes zinc oxide, believed to have an aerodynamic particle size from 50-150 nm, (available as MKN-ZnO-050P from MKnano Canada).
Isocyanate Polymeric methylene diphenyl diisocyanate (PMDI) (available as PAPI™ 27 from The Dow Chemical Company).
Catalyst 1 A dibutyltin dilaurate based catalyst that promotes the urethane or gelling reaction (available as Dabco® T-12 from Air Products).
Catalyst 2 A tertiary amine based catalyst that promotes the polyisocyanurate reaction, i.e., trimerization (available as Dabco® TMR from Air Products).
Coupling Agent A silane coupling agent, gamma-aminopropyltriethoxysilane (available as Silquest™ A-1100 from Momentive).
Surfactant A surfactant based on cocamidopropyl hydroxysultaine (for example, available from Lubrizol).

The approximate conditions (e.g., with respect to time and amounts) and properties for forming Working Examples 1 to 3 and Comparative Examples A and B. are discussed below.

### Coated Working Example 1

Coated sand of Working Example 1 has a coated structure that includes 2.0 wt % of a top coat having 0.5 wt % of the Zinc Oxide embedded in a polyurethane polymer matrix, weight percentages being based on the total weight of the coated sand. The topcoat is prepared using the Polyol and the Isocyanate at an isocyanate index of 190, and includes 100 parts per resin (total amount of polyol) of the Zinc Oxide.

In particular, Working Example 1 is prepared using 750 grams of the Sand, which is first heated in an oven to 135° C. to 145° C. Separately, in a beaker a Pre-mix that includes a stirred mixture of 3.6 grams of the Polyol, 3.6 grams of Zinc Oxide, 0.2 grams of Catalyst 1, and 0.3 grams of Catalyst 2, is formed.

The coating of Working Example 1 is started when the Sand, have a temperature around 125° C., is introduced into a KitchenAid® mixer equipped with a heating jacket, to start a mixing process. During the above process, the heating jacket is maintained at 60% maximum voltage (maximum voltage is 120 volts, where the rated power is 425 W and rated voltage is 115V for the heating jacket) and the mixer is set to medium speed (speed setting of 5 on based on settings from 1 to 10). To start the coating process of the Sand, 0.4 mL of the Coupling Agent is added to the Sand in the mixer, while the medium speed is maintained. Next, 15 seconds from the start of the addition of the Coupling Agent, the Pre-mix is added to the mixer simultaneously with 11.3 grams of the Isocyanate over a period of 75 seconds. Then, 120 seconds after finishing the addition the Pre-mix and the Isocyanate (˜3.5 minutes after the start of the addition of the Coupling Agent), the mixer is stopped and the coated Sand is emptied onto a tray and allowed to cool at room temperature (approximately 23° C.).

### Coated Working Example 2

Coated sand of Working Example 2 has a coated structure that includes 2.9 wt % of a top coat having 1.0 wt % of zinc oxide embedded in a polyurethane polymer matrix, weight percentages being based on the total weight of the coated sand. The topcoat is prepared using the Polyol and the Isocyanate at an isocyanate index of 70, and includes 67 parts per resin of the Zinc Oxide.

In particular, Working Example 2 is prepared using 750 grams of the Sand, which is first heated in an oven to 115° C. to 125° C. Separately, in a beaker a Pre-mix that includes a stirred mixture of 11.0 grams of the Polyol, 7.4 grams of Zinc Oxide, and 0.3 grams of Catalyst 1, is formed.

The coating of Working Example 2 is started when the Sand, have a temperature around 105° C., is introduced into a KitchenAid® mixer equipped with a heating jacket, to start a mixing process. During the above process, the heating jacket is maintained at 60% maximum voltage (maximum voltage is 120 volts, where the rated power is 425 W and rated voltage is 115V for the heating jacket) and the mixer is set to medium speed (speed setting of 5 on based on settings from 1 to 10). To start the coating process of the Sand, 0.6 mL of the Coupling Agent is added to the Sand in the mixer, while the medium speed is maintained. Next, 15 seconds from the start of the addition of the Coupling Agent, the Pre-mix is added to the mixer simultaneously with 11.5 grams of the Isocyanate over a period of 75 seconds. Then, 120 seconds after finishing the addition the Pre-mix and the Isocyanate (˜3.5 minutes after the start of the addition of the Coupling Agent), the mixer is stopped and the coated Sand is emptied onto a tray and allowed to cool at room temperature (approximately 23° C.).

### Coated Working Example 3

Coated sand of Working Example 3 has a coated structure that includes 2.9 wt % of a top coat having 0.5 wt % of zinc oxide embedded in a polyurethane polymer matrix, weight percentages being based on the total weight of the coated sand. The topcoat is prepared using the Polyol and the Isocyanate at an isocyanate index of 70, and includes 35 parts per resin of the Zinc Oxide.

In particular, Working Example 3 is prepared using 750 grams of the Sand, which is first heated in an oven to 115° C. to 125° C. Separately, in a beaker a Pre-mix that includes a stirred mixture of 11.0 grams of the Polyol, 3.8 grams of Zinc Oxide, and 0.3 grams of Catalyst 1, is formed.

The coating of Working Example 3 is started when the Sand, have a temperature around 105° C., is introduced into a KitchenAid® mixer equipped with a heating jacket, to start a mixing process. During the above process, the heating jacket is maintained at 60% maximum voltage (maximum voltage is 120 volts, where the rated power is 425 W and rated voltage is 115V for the heating jacket) and the mixer is set to medium speed (speed setting of 5 on based on settings from 1 to 10). To start the coating process of the Sand, 0.6 mL of the Coupling Agent is added to the Sand in the mixer, while the medium speed is maintained. Next, 15 seconds from the start of the addition of the Coupling Agent, the Pre-mix is added to the mixer simultaneously with 11.5 grams of the Isocyanate over a period of 75 seconds. Then, 120 seconds after finishing the addition the Pre-mix and the Isocyanate (˜3.5 minutes after the start of the addition of the Coupling Agent), the mixer is stopped and the coated Sand is emptied onto a tray and allowed to cool at room temperature (approximately 23° C.).

### Coated Comparative Example A

Coated sand of Comparative Example A has a coated structure that includes 2.0 wt % of a top coat having a polyurethane polymer matrix, weight percentage being based on the total weight of the coated sand. The topcoat is prepared using the Polyol and the Isocyanate at an isocyanate index of 200, and excludes the Zinc Oxide.

In particular, Comparative Example A is prepared using 750 grams of the Sand, which is first heated in an oven to 135° C. to 145° C. Separately, in a beaker a Pre-mix that includes a stirred mixture of 3.6 grams of the Polyol, 0.1 grams of Catalyst 1, and 0.2 grams of Catalyst 2, is formed.

The coating of Comparative Example A is started when the Sand, have a temperature around 125° C., is introduced into a KitchenAid® mixer equipped with a heating jacket, to start a mixing process. During the above process, the heating jacket is maintained at 60% maximum voltage (maximum voltage is 120 volts, where the rated power is 425 W and rated voltage is 115V for the heating jacket) and the mixer is set to medium speed (speed setting of 5 on based on settings from 1 to 10). To start the coating process of the Sand, 0.4 mL of the Coupling Agent is added to the Sand in the mixer, while the medium speed is maintained. Next, 15 seconds from the start of the addition of the Coupling Agent, the Pre-mix is added to the mixer simultaneously with 11.3 grams of the Isocyanate over a period of 75 seconds. Then, 120 seconds after finishing the addition the Pre-mix and the Isocyanate (˜2.5 minutes after the start of the addition of the Coupling Agent), the mixer is stopped and the coated Sand is emptied onto a tray and allowed to cool at room temperature (approximately 23° C.).

### Coated Comparative Example B

Coated sand of Comparative Example B has a coated structure that includes 2.9 wt % of a top coat having a polyurethane polymer matrix, weight percentage being based on the total weight of the coated sand. The topcoat is prepared using the Polyol and the Isocyanate at an isocyanate index of 70, and excludes the Zinc Oxide.

In particular, Comparative Example A is prepared using 750 grams of the Sand, which is first heated in an oven to 115° C. to 125° C. Separately, in a beaker a Pre-mix that includes a stirred mixture of 11.1 grams of the Polyol and 0.4 grams of Catalyst 1, is formed.

The coating of Working Example 1 is started when the Sand, have a temperature around 105° C., is introduced into a KitchenAid® mixer equipped with a heating jacket, to start a mixing process. During the above process, the heating jacket is maintained at 60% maximum voltage (maximum voltage is 120 volts, where the rated power is 425 W and rated voltage is 115V for the heating jacket) and the mixer is set to medium speed (speed setting of 5 on based on settings from 1 to 10). To start the coating process of the Sand, 0.6 mL of the Coupling Agent is added to the Sand in the mixer, while the medium speed is maintained. Next, 15 seconds from the start of the addition of the Coupling Agent, the Pre-mix is added to the mixer simultaneously with 11.4 grams of the Isocyanate over a period of 60 seconds. Then, 45 seconds thereafter, 1.0 mL of the Surfactant is added. Then, 60 seconds after finishing the addition the Surfactant (˜3.0 minutes after the start of the addition of the Coupling Agent), the mixer is stopped and the coated Sand is emptied onto a tray and allowed to cool at room temperature (approximately 23° C.).

### Evaluation of Properties

Working Examples 1 to 3, Comparative Examples A and B, and three Control Examples, are evaluated for hydrogen sulfide capture. The three Control Examples include: Control Example C (no proppants), Control Example D (raw sand without any coatings formed thereon), and Control Example E (Zinc Oxide in powder form). The evaluation for hydrogen sulfide captures includes: (i) hydrogen sulfide content in vapor phase after 1 hour of exposure, in parts per million by volume (ppmv), and (ii) hydrogen sulfide capture, in percent. The evaluation is carried out using two grams of examples and 10 mL of deionized water in a GC vial, at a temperature of 70° C. As would be understood by a person of ordinary skill in the art, hydrogen sulfide content in vapor phase is measured by an Agilent gas chromatography equipped with a Restek Rt-Q-Bond column, a thermal conductivity detector, and pulsed discharge ionization detector. Hydrogen sulfide capture efficiency is calculated by comparing with a blank sample in the absence of sand, as would be understood by a person of ordinary skill in the art.

In particular, for the hydrogen sulfide capture studies 2.0 grams of the corresponding sample (coated sand samples for Working Examples 1 to 3 and Comparative Examples A and B, and uncoated sand sample for Control Example D) are weighted into a 22-mL headspace GC vial with a stir bar. For Control Example C, nothing is placed in the GC vial. For Control Example E, 10 mg of the Zinc Oxide in powder form is placed in the GC vial. Then, deionized water (10 mL) or tetradecane (10 mL) is added into each vial and sealed with a PTEF lined silicon crimp cap. Next, hydrogen sulfide gas (1.5 mL, STP equivalent to 2.28 mg) is injected into the headspace of each vial. The vials are then heated at 70° C. in the case of water or 110° C. in the case of tetradecane in an aluminum heating block on top of a stirring hot plate for 1 hour. Thereafter, the vials are cooled and the hydrogen sulfide concentrations in the headspace of the vials are analyzed by headspace gas chromatography.

The results for samples suspending in water are shown in Table 1, below:

TABLE 1

| | Ex. 1 | Ex. 2 | Ex. 3 | Ex. A | Ex. B | Ex. C | Ex. D | Ex. E |
|---|---|---|---|---|---|---|---|---|
| Amount of | 2.0 | 2.9 | 2.9 | 2.0 | 2.9 | — | — | — |
| Coating (wt %) | | | | | | | | |
| Index for Coating | 200 | 70 | 70 | 200 | 70 | — | — | — |
| Zinc Oxide in | 0.5 | 1.0 | 0.5 | — | — | — | — | — |
| Coating (wt %) | | | | | | | | |
| Amount Zinc | — | — | — | — | — | — | — | 10 |
| Oxide Powder (mg) | | | | | | | | |
| Hydrogen Sulfide | 1068 | 0 | 370 | 2537 | 2604 | 3133 | 2498 | 0 |
| Content in Vapor | | | | | | | | |
| Phase (ppmv) | | | | | | | | |
| Hydrogen Sulfide | 66 | 100 | 88 | 19 | 17 | — | 20 | 100 |
| Capture (%) | | | | | | | | |

The results for samples suspending in tetradecane are shown in Table 2, below:

TABLE 2

| | Ex. 1 | Ex. 2 | Ex. 3 | Ex. A | Ex. B | Ex. C | Ex. D | Ex. E |
|---|---|---|---|---|---|---|---|---|
| Amount of | 2.0 | 2.9 | 3.0 | 2.9 | 2.9 | — | — | — |
| Coating (wt %) | | | | | | | | |
| Index for Coating | 200 | 70 | 70 | 200 | 70 | — | — | — |
| Zinc Oxide in | 0.5 | 1.0 | 0.5 | — | — | — | — | — |
| Coating (wt %) | | | | | | | | |
| Amount Zinc | — | — | — | — | — | — | — | 10 |
| Oxide Powder (mg) | | | | | | | | |
| Hydrogen Sulfide | 1348 | 605 | 1033 | 1718 | 1713 | 1822 | 1792 | 906 |
| Content in Vapor | | | | | | | | |
| Phase (ppmv) | | | | | | | | |
| Hydrogen Sulfide | 26 | 67 | 43 | 6 | 6 | — | 2 | 50 |
| Capture (%) | | | | | | | | |

Referring to Tables 1 and 2, it is seen that low hydrogen sulfide content in vapor phase and higher percentage of capture of hydrogen sulfide, is realized for each of Working Examples 1 to 3. Further, referring to Control Example E, it is shown that Working Examples 1 to 3 are able to realize properties similar to as since with just adding Zinc Oxide, but without the disadvantages associated with just adding a powder like Zinc Oxide to contaminated water during a fracturing process (such issues related to scaling when added powders, issues related to logistics of when and where to add such a powder, issues related to dispersing the powder in an effective manner at an industrial scale, etc.). In contrast, Comparative Examples A and B, which do not include Zinc Oxide in the coating, each show significantly higher amount of hydrogen sulfide content in vapor phase and significantly lower percentage of capture of hydrogen sulfide. Also, Control Example C shows the hydrogen sulfide content in vapor phase and percentage of capture of hydrogen sulfide, without the addition of any additives. Control Example D shows the hydrogen sulfide content in vapor phase and percentage of capture of hydrogen sulfide, when raw sand is used.

### Epoxy Examples

Liquid epoxy resin based examples may be preparing using the following:
Epoxy Resin 1 A liquid epoxy resin that is a reaction product of epichlorohydrin and bisphenol A (available from The Dow Chemical Company as D.E.R.™ 331).
Epoxy Toughener A toughened epoxy binder (available as VORASPEC™ 58 from The Dow Chemical Company).
Epoxy Hardener An aliphatic polyamine curing agent (available as D.E.H™ 26 from The Dow Chemical Company).
Polyether Polyol An ethoxylated polyhydric polyol (available from The Dow Chemical Company).
Zinc Oxide A powder that includes zinc oxide, believed to have an aerodynamic particle size from 50-150 nm, (available as MKN-ZnO-050P from MKnano Canada).
Catalyst 1 A dibutyltin dilaurate based catalyst that promotes the urethane or gelling reaction (available as Dabco® T-12 from Air Products®).

The liquid epoxy resin samples may be prepared in a process similar to as discussed in priority filing U.S. Provisional Patent Application No. 62/186,645. For example, samples may be prepared by blending the components (except the Epoxy Hardener and/or the Polyether Polyol) at 3500 rpm for 45 seconds in a FlackTek SpeedMixer™. Then, the blend may be placed in an oven for one hour at 60° C. Then, Epoxy Hardener and/or the Polyether Polyol may be added. A stoichiometric ratio of the Amino Hydrogen groups in the formulations to the Liquid Epoxy Resin is calculated as the Amino Hydrogen/LER stoichiometric ratio.

### Phenolic Resin Examples

For phenolic resin based examples, the materials principally used, and the corresponding approximate properties thereof, are as follows:
Phenolic Resin 1 A phenol-formaldehyde Novolac resin (available as SD-1731 from Hexion).
Phenolic Resin 2 A resole resin (available as 102N68 from Georgia Pacific).
Polyol A blend of polyols (available from The Dow Chemical Company as TERAFORCE™ 62575 Polyol).
Zinc Oxide A powder that includes zinc oxide, believed to have an aerodynamic particle size from 50-150 nm, (available as MKN-ZnO-050P from MKnano Canada).
HEXA An aqueous solution of hexamethylenetetramine Hexamethylenetetramine (available from Sigma-Aldrich).

Working Examples, are prepared according to the formulations in Table 3, below.

TABLE 3

| | | | | |
|---|---|---|---|---|
| Ex. 7 | Ex. 8 | Ex. 9 | Ex. H | Ex. I |

Formulation (wt %)

| | | | | | |
|---|---|---|---|---|---|
| Phenolic Resin 1 | NA | NA | NA | NA | NA |
| Phenolic Resin 2 | NA | NA | NA | NA | NA |
| Polyol | NA | NA | NA | NA | NA |
| Zinc Oxide | NA | NA | NA | NA | NA |

Properties

| | | | | | |
|---|---|---|---|---|---|
| Amount of Coating | NA | NA | NA | NA | NA |
| (wt %) | | | | | |
| Index for Coating | NA | NA | NA | NA | NA |
| Zinc Oxide in | NA | NA | NA | NA | NA |
| Coating (wt %) | | | | | |
| Amount Zinc Oxide | NA | NA | NA | NA | NA |
| Powder (mg) | | | | | |
| Hydrogen Sulfide | NA | NA | NA | NA | NA |
| Content in Vapor | | | | | |
| Phase (ppmv) | | | | | |
| Hydrogen Sulfide | NA | NA | NA | NA | NA |
| Capture (%) | | | | | |

The coating of the examples is started when the Sand, have a temperature around 400° C., is introduced into a KitchenAid® mixer equipped with a heating jacket, to start a mixing process. During the above process, the heating jacket is maintained at 60% maximum voltage (maximum voltage is 120 volts, where the rated power is 425 W and rated voltage is 115V for the heating jacket) and the mixer is set to medium speed (speed setting of 5 on based on settings from 1 to 10). To start the coating process of the 2000 grams of Sand (after letting the temperature equilibrate to 375° C.), 40 grams of the Phenolic Resin 1 is added to the Sand in the mixer, while the medium speed is maintained. Separately, a polyol suspension of 11.0 grams of the Polyol 7.4 grams Zinc Oxide is formed. Next, 18.4 grams of the polyol suspension is added to the mixer. After, 30 seconds from the addition of the polyol suspension, 36.0 grams of the HEXA is added to the mixer over a period of 30 seconds. Next, 25 grams of the Phenolic Resin 2 is added to the mixer. Then, 200 seconds after finishing the addition the Phenolic Resin 2, the mixer is stopped and the coated Sand is emptied onto a tray and allowed to cool at room temperature (approximately 23° C.).

1. A coated proppant, comprising:
a solid core proppant particle; and
a sulfide recovery coating, including a sulfide capturing agent embedded within a polymer resin matrix, the sulfide capturing agent being a metal oxide.

2. The coated proppant as claimed in claim 1, wherein sulfide capturing agent includes sulfide capturing crystals that have a melting point greater than 500° C.

3. The coated proppant as claimed in claim 1, wherein sulfide capturing agent includes zinc oxide.

4. The coated proppant as claimed in claim 1, wherein the sulfide capturing agent is provided in a carrier polymer, the carrier polymer including a polyol, a liquid epoxy resin, or a phenolic resin.

5. The coated proppant as claimed in claim 1, wherein the polymer resin matrix is at least one selected from the group of a polyurethane based matrix, an epoxy resin based matrix, and a phenolic resin based matrix.

6. A process for the manufacture of the coated proppant as claimed in claim 1, the process comprising:
providing the solid core proppant particle; and
forming on the solid core proppant particle, the sulfide recovery coating that includes a sulfide capturing agent embedded within a polymer resin matrix, the sulfide capturing agent being a metal oxide.

7. A coated article, the process comprising:
a solid article; and
a sulfide recovery coating that includes a sulfide capturing agent embedded within a polymer resin matrix, the sulfide capturing agent being a metal oxide.
